(19) United States
(12) Patent Application Publication
(10) Pub. No.: US 2026/0227579 A1
(43) Pub. Date: Aug. 6, 2026

(54) APPARATUS FOR ELECTROMAGNETIC MANIPULATION OF AN OPTICAL FIBER

(71) Applicant: nLIGHT, Inc., Camas, WA (US)

(72) Inventors: Mark DeFranza, Vancouver, WA (US); Aaron Hodges, Vancouver, WA (US); Aaron Brown, Vancouver, WA (US); Dahv Kliner, Portland, OR (US)

(21) Appl. No.: 19/458,133

(22) Filed: Jan. 23, 2026

Related U.S. Application Data
(60) Provisional application No. 63/752,071, filed on Jan. 31, 2025.

(51) Int. Cl. G02B 6/36; H01F 7/02; H01F 7/16

(52) U.S. Cl. CPC G02B 6/3616; G02B 6/3636; H01F 7/0221; H01F 7/1646

(57) ABSTRACT

A perturbation assembly includes an optical fiber having a first end and a second end, a first support, where the first end of the optical fiber is secured to the first support, a first electromagnetic coil disposed adjacent to the optical fiber, a controller, and a first communication link connecting the first electromagnetic coil to the controller. In response to receipt of a control signal from the controller, the first electromagnetic coil vibrates the optical fiber at a frequency within a range of 100 Hz to 50 kHz.

### CROSS-REFERENCE TO RELATED APPLICATION(S)

This application relies on and claims priority benefit of U.S. Provisional Application No. 63/752,071, filed Jan. 31, 2025, the entire contents of which are incorporated herein by reference.

### FIELD OF THE INVENTION

The present invention concerns an apparatus for manipulating an optical fiber using an electromagnetic manipulator.

### DESCRIPTION OF THE RELATED ART

As described in U.S. Pat. No. 10,423,015 (hereinafter “the '015 patent”), titled “Adjustable Beam Characteristics,” and its related patents, nLIGHT, Inc. developed technology for varying beam properties by controlling a spatial intensity distribution of a laser beam, i.e., adjusting its near-field intensity distribution. The entire content of the '015 patent is incorporated herein by reference.

The '015 patent describes a fiber operable to provide a laser beam having variable beam characteristics (VBC) that may reduce cost, complexity, optical loss, or other drawbacks of the conventional methods. This VBC device is configured to vary a wide variety of optical beam characteristics. Such beam characteristics can be controlled using the VBC device thus allowing users to tune various beam characteristics to suit the particular requirements of an extensive variety of laser processing applications. For example, a VBC device may be used to tune: beam diameter, divergence distribution, BPP, intensity distribution, M2 factor, NA, optical intensity, power density, radial beam position, radiance, spot size, or the like, or any combination thereof.

In some embodiments, the '015 patent describes adjusting the coupling of the beam into a so-called ring fiber, which has two or more guiding regions. A ring fiber has one or more annular cores optionally surrounding a central (non-annular) core, with low-index glass layers separating the cores so that light coupled into a core will be guided in that core. The angular intensity distribution of the beam need not be directly controlled and depends on various factors such as the laser divergence, bending of the upstream optical fibers, and overlap of the near-field transverse spatial intensity distribution with the guiding confinement regions of the ring fiber.

To achieve a variety of beam diameters and shapes using embodiments and techniques described in the '015 patent, the '015 Patent describes how to perturb an optical fiber to change the bend radius of the optical fiber. Changing the bend radius of the fiber may change the radial beam position, divergence angle, and/or radiance profile of the beam within the optical fiber.

In one embodiment, the '015 Patent describes a perturbation assembly 210 that includes rollers 250 that engage the VBC fiber 200 across the perturbation assembly 210. The rollers 250 alter the bend radius of the optical fiber 200 to vary the characteristics of the light beam.

One difficulty with the apparatus described in the '015 application lies in the fact that the operational frequency of the perturbation assembly 210 is limited by the ability of the device to move the rollers 250, among others.

### SUMMARY OF THE INVENTION

The present invention provides one or more advantages over the prior art.

Among the advantages, the present invention provides a perturbation assembly that operates at a frequency higher than the operational frequency of one or more prior art devices.

Specifically, the present invention provides a perturbation assembly that includes an optical fiber having a first end and a second end, a first support, where the first end of the optical fiber is secured to the first support, a first electromagnetic coil disposed adjacent to the optical fiber, a controller, and a first communication link connecting the first electromagnetic coil to the controller. In response to receipt of a control signal from the controller, the first electromagnetic coil vibrates the optical fiber at a frequency within a range of 100 Hz to 50 KHz.

In one contemplated embodiment of the perturbation assembly of the present invention, the first support further includes a first v-groove within which the first end of the optical fiber is secured and an epoxy adhering the first end of the optical fiber within the v-groove.

In another embodiment, it is contemplated that the first electromagnetic includes a first core and a first coil disposed around the first core.

For the perturbation assembly of the present invention, the frequency is contemplated to fall within a range of 40 kHz±10%. The frequency also may fall within a range of 40 kHz±5%. Still further, the frequency may be within a range of 40 kHz±2%. Additionally, the frequency may satisfy a range of 40 kHz±1%.

It is also contemplated that the perturbation assembly may include a second electromagnetic coil disposed adjacent to the optical fiber and a second communication link connecting the second electromagnetic coil to the controller. In response to receipt of a control signal from the controller, the second electromagnetic coil vibrates the optical fiber at the frequency.

In another contemplated embodiment, the perturbation assembly of the present invention may have a first magnet disposed on the optical fiber between the first end and the second end, where the first electromagnetic coil generates a magnetic field that interacts with the first magnet to vibrate the optical fiber at the frequency. If so, a second electromagnetic coil may be disposed adjacent to the optical fiber and a second communication link may connect the second electromagnetic coil to the controller. Here, the second electromagnetic coil is contemplated to generate a magnetic field that interacts with the first magnet to vibrate the optical fiber at the frequency in cooperation with the first electromagnetic coil.

Next, it is contemplated that the controller may provide the control signal to the first electromagnetic coil to vary the frequency according to a predetermined operational sequence.

The perturbation assembly of the present invention also may include a second support, where the second end of the optical fiber is secured to the second support.

In one contemplated embodiment, the perturbation assembly includes a second electromagnetic coil disposed adjacent to the optical fiber and a second communication link connecting the second electromagnetic coil to the controller. Here, in response to receipt of a control signal from the controller, the second electromagnetic coil vibrates the optical fiber at a frequency within a range of 100 Hz to 50 kHz and the second electromagnetic coil cooperates with the first electromagnetic coil to vibrate the optical fiber.

In the perturbation assembly of the present invention, a second magnet may be disposed on the optical fiber between the first end and the second end. Here, a third electromagnetic coil may be disposed adjacent to the optical fiber, a third communication link may connect the third electromagnetic coil to the controller, a fourth electromagnetic coil may be disposed adjacent to the optical fiber, and a fourth communication link may connect the fourth electromagnetic coil to the controller. In response to receipt of a control signal from the controller, the third and fourth electromagnetic coils are contemplated to vibrate the optical fiber at the frequency. The third electromagnetic coil cooperates with the fourth electromagnetic coil to vibrate the optical fiber in association with the second magnet.

Other advantages of the present invention will be made apparent from the discussion that follows.

### BRIEF DESCRIPTION OF THE DRAWINGS

The present invention will now be described in connection with the drawings appended hereto, in which:

FIG. 1 is a perspective view of a first embodiment of a perturbation assembly according to the present invention;

FIG. 2 is a perspective view of a second embodiment of a perturbation assembly according to the present invention;

FIG. 3 is a perspective view of a third embodiment of a perturbation assembly according to the present invention;

FIG. 4 is a perspective view of a fourth embodiment of a perturbation assembly according to the present invention;

FIG. 5 is a perspective view of a fifth embodiment of a perturbation assembly according to the present invention;

FIG. 6 is a perspective view of a sixth embodiment of a perturbation assembly according to the present invention;

FIG. 7 is a perspective view of a seventh embodiment of a perturbation assembly according to the present invention; and

FIG. 8 is a perspective view of an eighth embodiment of a perturbation assembly according to the present invention.

### DETAILED DESCRIPTION OF EMBODIMENT(S) OF THE INVENTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems and apparatuses described herein should not be construed as limiting in any way. Instead, the present disclosure is directed toward all novel and non-obvious features and aspects of the various disclosed embodiments, alone and in various combinations and sub-combinations with one another. The disclosed systems, methods, and/or apparatuses are not limited to any specific aspect or feature or combinations thereof, nor do the disclosed systems, methods, and/or apparatuses require that any one or more specific advantages be present, or problems be solved. Any theories of operation are to facilitate explanation, but the disclosed systems, methods, and/or apparatuses are not limited to such theories of operation.

Where applicable, the operations of some of the disclosed methods are described in a particular, sequential order for convenient presentation. It should be understood, however, that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatuses can be used in conjunction with other systems, methods, and apparatuses. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by skilled persons.

In some examples, values, procedures, or apparatuses are referred to as “lowest,” “best,” “minimum,” or the like. It will be appreciated that such descriptions are intended to indicate that a selection among many used functional alternatives can be made, and such selections need not be better, smaller, or otherwise preferable to other selections. Examples are described with reference to directions indicated as “above,” “below,” “upper,” “lower,” and the like. These terms are used for convenient description, but do not imply any particular spatial orientation. Moreover, in the following examples, laser components and assemblies are described at a high level of abstraction and do not include a complete description of all mechanical, electrical, and optical elements necessary for operation.

In the discussion that follows, similar elements and features may be discussed as “first,” “second,” third,” etc. Such discussion should not convey that the elements and features are identical to one another. Similarly, the use of “first,” “second,” third,” etc. is not intended to convey any particular hierarchy between the elements and/or features. The use of “first,” “second,” third,” etc., is intended to follow grammatical convention. Accordingly, an element identified as “first” in one instance may be referred to as “third” in another.

Before discussing various embodiments of the present invention, it is noted that a fiber laser system includes an optical fiber that directs laser light onto a target. The laser light, which is generated typically by one or more semiconductor laser diodes, usually has a wavelength that falls within the infrared portion of the electromagnetic spectrum. The target may be, for example, one or more pieces of metal that require welding, engraving, scoring, etc.

The light beam that is generated by the laser diode(s) travels through the optical fiber from the laser diode(s) to the target, which is also referred to as the workpiece. While the light travels through the optical fiber, it is desirable to manipulate one or more characteristics of the laser light so that the laser light may be more suitably applied to the target. For example, it is desirable for the laser light exiting from the optical fiber to have a generally uniform cross-section. This may facilitate more uniform welding, for example. Other shapes and profiles for the light emerging from the optical fiber are known to those skilled in the art. It is noted that the present invention is not limited to any particular profile for the light emitted from the optical fiber.

To change the profile (among other properties and characteristics) of the light beam exiting from the optical fiber, the optical fiber may be manipulated at one or more locations along the length of the optical fiber. Manipulating the optical fiber leads to variations in the operating mode of the laser output.

In general, there are several classes of manipulation of the optical fiber that may be used to perturb the laser operating mode. If properly configured, these manipulations may be used in beneficial ways. These manipulations include bending the fiber, vibrating the fiber, compressing the fiber, and twisting the fiber, etc.

In the optical system discussed, for example, in the '015 Patent, the operating mode of the laser system is altered by bending the optical fiber. In particular, by bending the optical fiber, the intensity pattern (or profile) of the emergent light is changed.

As discussed in the '015 Patent, the optical fiber is bent via a small motor and cam system that pushes on the fiber to cause a displacement of the optical fiber, thus shifting the operating mode. The displacement is controlled by the amount of rotation imparted to the cam, which pushes the fiber by a distance based on the rotation.

As may be apparent, the bending of the optical fiber by the cam system described by the '015 Patent is limited by the speed at which the motor accelerates the mass of the cam system to cause the motion which results in the fiber deflection. It is understood that the minimum time to accomplish the mechanical motion to cause a mode shift is approximately 20 milliseconds, which results in a maximum movement rate of 50 Hz.

As identified hereinabove, a more rapid movement of the optical fiber is desirable, because a more rapid movement of the optical fiber has the intended effect of more fully homogenizing the optical output of the fiber laser. Specifically, the more rapid the movement of the optical fiber, the better the homogenization of the laser light output from the optical fiber.

As detailed in connection with the embodiments described in connection with the perturbation assemblies of the present invention, a means is provided to rapidly displace the optical fiber location using electromagnetic fields. Specifically, by applying a magnetic or electrically conducting material onto the body of the optical fiber, magnetic and/or electric fields may be employed to provide the force needed to displace the optical fiber and create desirable optical conditions.

In the embodiments described hereinbelow, the present invention encompasses, inter alia, perturbation assemblies that operate to apply external forces to an optical fiber via at least one of: (1) electrostatic means or (2) magnetic fields.

In the first instance, to apply a bending force to an optical fiber via electrostatic means, an electrically conducting surface is added to the surface of the optical fiber. The optical fiber may be manipulated by applying a voltage potential difference between the optical fiber and a set of electrically conducting surfaces positioned on one or more sides of the optical fiber.

It is appreciated, however, that there are some challenges associated with the use of electrostatic forces to manipulate the orientation of the optical fiber. In particular, there are technical challenges to providing a suitable conductive layer to the surface of the optical fiber. Still further, the voltages that might need to be applied to the optical fiber to displace the optical fiber to a suitable degree might raise safety concerns.

At least for these reasons, the various embodiments of the present invention rely on the use of magnetic fields to alter the shape of the optical fiber.

In the second instance, to apply magnetic fields to the optical fiber, a material, such as a permanent magnet, is placed onto the optical fiber. The magnet possesses a magnetic moment through which an external magnetic field generates a force on the optical fiber. In another contemplated embodiment, magnetically generated forces are generated to push directly on the optical fiber and cause a displacement or deformation of the optical fiber.

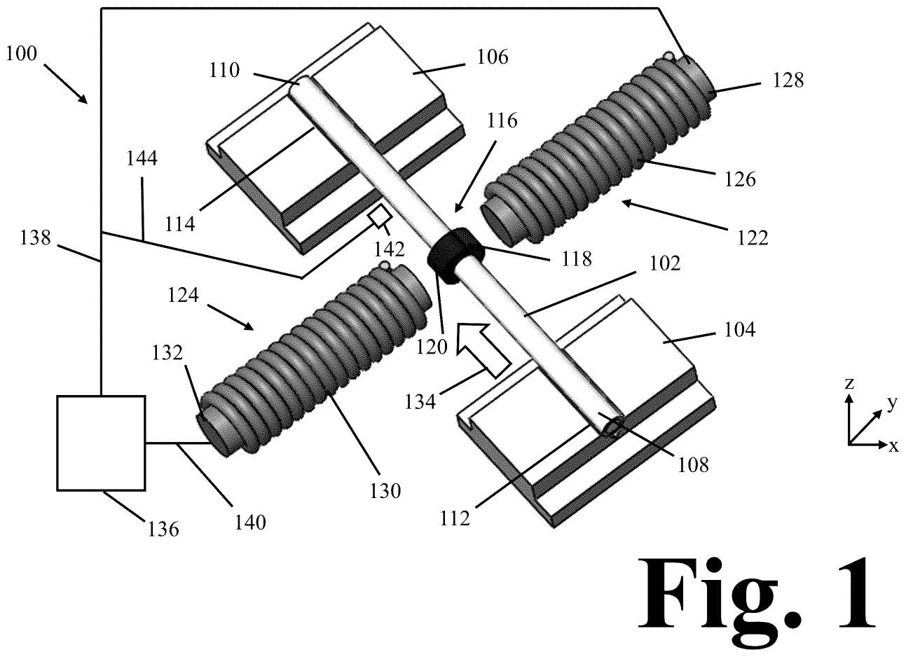

FIG. 1 is a perspective illustration of a first embodiment of a perturbation assembly 100 according to the present invention.

The perturbation assembly 100 is constructed to manipulate the optical fiber 102, thereby altering the characteristics of the light outputted from the optical fiber 102.

In FIG. 1, the optical fiber 102 is illustrated as a single core optical fiber 102 with a cladding. It is noted, however, that the perturbation assembly 100 may operate on any suitable type of optical fiber 102 without departing from the scope of the present invention. The remaining embodiments of the present invention also are intended to operate in connection with any type of optical fiber known to those skilled in the art.

As shown in FIG. 1, the optical fiber 102 is disposed between a first support 104 and a second support 106. The first and second supports 104, 106 secure the optical fiber 102 at a first end 108 and at a second end 110 thereof.

For operation of the perturbation assembly 100, the optical fiber 102 may be secured at the first and 108 and the second end 110 by any suitable means including, for example, clamps, adhesives, etc. In the illustrated embodiment, the first end 108 of the optical fiber 102 is secured to the first support 104 via an adhesive. Similarly, the second end 110 of the optical fiber 102 is secured to the second support 106 via an adhesive.

The first and second supports 104, 106 are contemplated to be silicon v-groove support structures. The v-groove supports 104, 106 include first and second v-grooves 112, 114, as the name suggests. As noted the optical fiber 102 may be held in place using adhesive, ferrules, machined grooves, clamps, or other means. The silicon v-groove supports 104, 106 are desirable, because the v-grooves 112, 114 do not have to be threaded onto the optical fiber 102. If a ferrule is employed, for example, a threaded engagement would be required. In addition, the v-groove supports 104, 106 are easy to manufacture and assemble.

As noted, the optical fiber 102 is contemplated to be secured in the first and second supports 104, 106 via an adhesive, such as an epoxy. While an epoxy is contemplated for use, other types of adhesives may be employed without departing from the scope of the present invention.

In the space between the two v-groove supports 104, 106, the optical fiber 102 is permitted to move (or flex) laterally and/or vertically depending on the magnitude and the direction of a force applied to the optical fiber 102 suspended between the first support 104 and the second support 106.

As illustrated in FIG. 1, a magnet 116 is positioned at the center point of the optical fiber 102. The center point is defined as the location that is equidistant from the first support 104 and the second support 106.

The magnet 116 has a north pole 118 and a south pole 120.

A first electromagnetic coil 122 is disposed on one side of the optical fiber 102. In FIG. 1, the first electromagnetic coil 122 is disposed adjacent to the north pole 118 of the magnet 116. In addition, a second electromagnetic coil 124 is disposed on the opposite side of the optical fiber 102. As shown in FIG. 1, the second electromagnetic coil 124 is disposed adjacent to the south pole 120 of the magnet 116. Being disposed adjacent to the magnet 116, the first electromagnetic coil 122 and the second electromagnetic coil 124 are disposed at the center point of the optical fiber 102 between the first support 104 and the second support 106.

The first electromagnetic coil 122 includes a first coil 126 and a first core 128. Similarly, the second electromagnetic coil 124 includes a second coil 130 and a second core 132. It is noted that the configurations for the first and second electromagnetic coils 122, 124 are non-limiting examples. The electromagnetic coils 122, 124 may have any suitable construction within the scope of the present invention.

As should be apparent to those skilled in the art, by applying a current to the electromagnetic coils 122, 124, magnetic fields are generated that interact with the magnet 116. As such, by varying the currents applied to the electromagnetic coils 122, 124, it is possible to move the magnet 116. When the magnet 116 moves, the optical coil 102 is bent, altering one or more characteristics of the laser light 134 passing therethrough. The laser light is indicated by the arrow 134. While the direction of the laser light 134 is illustrated as travelling from the first support 104 to the second support 106, the laser light 134 may travel in the opposite direction, or in both directions, as should be apparent to those skilled in the art.

As should be apparent from the configuration illustrated in FIG. 1, the force applied by the magnetic coils 122, 124 on the magnet 116 is applied to the center point of the optical fiber 102. Moreover, with two electromagnetic coils 122, 124, the force is applied to either side of the optical fiber 102. As illustrated in connection with other embodiments of the present invention, this configuration is not limiting of the present invention. To the contrary, the force may be applied from any of a number of directions, and in complex shapes, without departing from the scope of the present invention. Moreover, the force may be applied to any point (or multiple points) at any position along the length of the optical fiber 102 between the supports 104, 106 depending on the magnitude of the force and the deflection desired.

A controller 136 is illustrated in FIG. 1. The controller 136 is contemplated to incorporate a processor that executes instructions to issue control signals to the electromagnetic coils 122, 124. Alternatively, the controller 136 may control the current applied to the electromagnetic coils 122, 124. The processor may incorporate a device that executes software instructions. Alternatively, the controller 136 may be hardwired to provide instructions to the electromagnetic coils 122, 124. The precise construction of the controller 136 and the manner in which the electromagnetic coils 122, 124 are controlled is within the level of ordinary skill and, therefore, is not discussed in greater detail herein.

As also shown in FIG. 1, a first communication link 138 connects the controller 136 to the first electromagnetic coil 122. A second communication link 140 connects the second electromagnetic coil 124 to the controller 136. The first and second communication links 138, 140 may be wired and/or wireless, as should be apparent to those skilled in the art.

With continued reference to FIG. 1, it is noted that the magnet 116 may be a permanent magnet. Alternatively, the magnet 116 may be a ferromagnetic material deposited onto the optical fiber 102. Still further, the magnet 116 may be a ferromagnetic bead secured to the optical fiber 102. Whether a permanent magnet, a ferromagnetic material, the permanent magnet or ferromagnetic material may be affixed to the optical fiber 102 via an adhesive, such as an epoxy or the like.

Where a permanent magnet is employed, the magnet 116 may be a neodymium magnet, for example. Other rare earth permanent magnet types also may be used without departing from the scope of the present invention. It is noted that the present invention is not limited to any particular type of magnet.

Concerning the electromagnetic coils 122, 124, it is noted that these coils are commonly referred to as solenoids. Solenoids are contemplated to provide one non-limiting option for the electromagnetic coils 122, 124. In addition, in the embodiments discussed herein, the electromagnetic coils 122, 124 include iron cores 128, 132 to enhance the magnetic fields generated thereby. The cores 128, 132 are not required to practice the present invention, as should be apparent to those skilled in the art.

Certain operational characteristics and parameters associated with the perturbation assembly 100 are now provided. It is noted, however, that these operational characteristics and parameters are not limiting of the present invention. Moreover, one or more of the characteristics and parameters are contemplated to be applicable to other embodiments, as should be apparent to those skilled in the art.

It is contemplated that the perturbation assembly 100 will operate to establish a resonant frequency for the optical fiber 102. The resonant frequency reflects one or more conditions where the least amount of force is needed to generate the largest mechanical deflection of the optical fiber 102. As should be apparent to those skilled in the art, the resonant frequency of the optical fiber 102 depends, at least in part, on the stiffness of the optical fiber 102, how tightly the optical fiber 102 is stretched between the supports 102, 104, and the distance or span between the supports 102, 104, among other variables.

Since the resonant frequency of the optical fiber 102 depends on one or more of the variables listed above, these variables may be adjusted to alter the resonant frequency of the optical fiber 102. For example, the resonant frequency of the optical fiber 102 may be changed by altering the diameter of the optical fiber 102. Still further, the resonant frequency may be altered by changing the materials used to construct the supports 102, 104. In addition, it is possible to alter the resonant frequency of the optical fiber 102 by changing the distance separating the supports 102, 104 from one another.

For one or more embodiments of the perturbation assembly 100 of the present invention, the resonant frequency of the optical fiber 102 is contemplated to be within a range from 100 to 50,000 Hz. For the perturbation assembly 100, one contemplated resonant frequency is 23 kHz. For another, the resonant frequency is contemplated to be 35 kHz.

For the embodiments of the present invention described herein, it is contemplated that the perturbation assemblies, such as the perturbation assembly 100, may be constructed so that the optical fiber 102 vibrates at or near a resonant frequency. As should be apparent to those skilled in the art, an object that vibrates at a resonant frequency requires less energy. Accordingly, by tailoring the perturbation assembly 100 such that the optical fiber 102 vibrates at one or more resonant frequencies, the perturbation assembly 100 is contemplated to operate at a lower energy cost.

For the perturbation assembly 100 illustrated in FIG. 1, the north pole 118 of the magnet 116 is positioned to face the first electromagnetic coil 122. The south pole 120 of the magnet 116 faces the second electromagnetic coil 124. With this arrangement, it is contemplated that the electromagnetic coils 122, 124 will be able to exert the strongest forces on the magnet 116 to impart the resonant frequency on the optical fiber 102.

Still further, with the electromagnetic coils 122, 124 disposed on either side of the optical fiber 102 in opposition to one another, it is contemplated that the electromagnetic coils 122, 124 may operate in manner to compliment one another. For example, the first electromagnetic coil 122 may operate to pull on the optical fiber 102 while the second electromagnetic coil 124 operates to push on the optical fiber 102. In this manner, the electromagnetic coil 124 provides additional force to add to the force generated by the first electromagnetic coil 122. Still further, one electromagnetic coil may be operated in a manner to provide a damping force to the operation of the opposing electromagnetic coil. Here, for example, the first electromagnetic coil 122 may be operated to pull on the optical fiber 102. To slow (or dampen) to movement of the optical fiber 102, the second electromagnetic coil 124 may be operated to apply a pulling force, albeit smaller than the pulling force of the first electromagnetic coil 122, on the optical fiber 102.

It is noted that the positioning of the magnet 116 need not be limited to the orientation illustrated in FIG. 1. In other contemplated embodiments, the magnet 116 may be rotated with respect to the electromagnetic coils 122, 124 to alter the effect of the electromagnetic coils 122, 124 thereon.

In connection with the perturbation assembly 100, it is noted that the contemplated operation involves imparting a resonant frequency into (or on) the optical fiber 102. However, it is also contemplated that the perturbation assembly 100 may be operated in a manner where the optical fiber 102 is maintained in a singular posture. In other words, the perturbation assembly 100 may operate in a manner that does not impart a resonance frequency into the optical fiber 102. This is referred to as a “steady state” mode of operation herein.

As should be apparent from the foregoing, by changing the magnitude of the current in the electromagnetic coils 122, 124, it is possible to change the magnitude of the magnetic fields generated thereby. Consequently, the force(s) applied to the optical fiber 102 may be altered by changing the current(s) applied to the electromagnetic coils 122, 124. As also should be apparent, by changing the polarity of the current in the electromagnetic coils 122, 124, the orientation of the magnetic field lines is changed to attract or repel the magnet 116.

Without limiting the scope of the present invention, some details are provided to highlight the operational parameters of the perturbation assembly 100 illustrated in FIG. 1.

The magnetic field strength that may be generated by the electromagnetic coils 122, 124 may be expressed by the following formula, equation (1). Specifically, the magnetic field strength B for the magnetic field at the center of the coil may be expressed as:

$$B = k * {u}_{0} * \frac{N}{L} * I \qquad Equation ( 1 )$$

Here, k is the relative permeability of the material chosen to form the core 128, 132 of the electromagnetic coil 122, 124. If the core 128, 132 is iron, the value k is 5000 Henrys per meter. In this equation, u0 is the permeability of free space. The permeability of free space may be 4π*10-7 H/m, for example. N is the number of coil windings. Lis the length of the solenoid or electromagnetic coil 122, 124. I is the applied current.

Calculating the magnetic field strength of an electromagnet that has 16 turns of wire with a diameter of 1 mm over a length of 5 millimeters, the field strength is 40 gauss per amp of drive current with no core material present. By increasing either the current, the number of windings, or the magnetic permeability of the core, the magnetic field strength may be increased. Therefore, it is contemplated that those skilled in the art would be encouraged to choose a material for the core 128, 132 with the highest permeability but also with the lowest cost. In addition, those skilled in the art might be motivated to use the largest number of windings that may be fit into the space available. In connection with the windings, those skilled in the art might elect to use a wire with the smallest diameter that will allow the maximum amount of current to flow without overheating the electromagnetic coil 122, 124. With these parameters, it is contemplated that a magnetic field strength of 1000 gauss may be generated using a small amount of current, using a high permittivity core, and using small gauge wire.

It is understood that the strength of the magnetic field is expected to drop at points away from the center of the coil. Specifically, the field strength at a distance from the center may be estimated by Equation (2) provided below.

$$B ( z ) = \frac{k * {u}_{0} N * I}{2} ( \frac{\frac{L}{2} - z}{L * \sqrt{{R}^{2} + {( \frac{L}{2} - z )}^{2}}} + \frac{\frac{L}{2} + z}{L * \sqrt{{R}^{2} + {( \frac{L}{2} + z )}^{2}}} ) \qquad Equation ( 2 )$$

Here, B(z) is the magnitude of the magnetic field at a position z. R is the coil radius. L is the coil length. z is a position along a coaxial line from the center point. As in Equation (1), u0 is the permeability of free space and N is the number of coil windings.

In practice, if the electromagnetic coils 122, 124 utilize a coil current I of approximately 1 ampere, the electromagnetic coils 122, 124 should generate a magnetic field of approximately 1000 gauss at a position that is 1 mm to 2 mm from the end of the electromagnetic coils 122, 124. This is contemplated to result in a force of approximately 100 g or 1 N that is imparted to the magnet 116. Based on a finite element analysis, it is calculated that the movement of the optical fiber 102 will be approximately 30 μm.

To estimate the frequency at which the optical fiber 102 may be manipulated, Equation (3) is employed.

$$F = {m}^{*} a \qquad Equation ( 3 )$$

F is the force applied to the optical fiber 102. m is the combination of the mass of the optical fiber 102, the mass of the magnet 116, and the mass of the epoxy used to adhere the magnet 116 to the optical fiber 102. a is the acceleration of the optical fiber 102.

It one contemplated embodiment, the force applied to the optical fiber 102 is IN and the combined mass of the optical fiber 102, the magnet 116, and the epoxy adhering the magnet 116 to the optical fiber 102 fiber is about 5 milligrams (5×10-6 kg). As a result, the acceleration a of the magnet 116 is calculated to be:

$$a = 1 N / 5 \times 10 - 6 kg = 200 , 000 \frac{meters}{{second}^{2}} .$$

If the desired time to move the optical fiber 102 from a rest position to another position is 10 microseconds (100 kHz), then the distance travelled by the optical fiber is given by Equation (4).

$$Distance = \frac{1}{2} * a * {t}^{2} \qquad Equation ( 4 )$$

Using the variables discussed above, Distance=0.5*200,000*0.000012=0.01 millimeters or 10 microns.

To increase the deflection distance, the combined mass of the optical fiber 102, the magnet 116, and the epoxy could be reduced. For example, a lighter magnet 116 could be used. Still further, the supports 122, 124 could be moved closer together. To generate a larger force, additional current could be applied to the electromagnetic coils 122, 124. Alternatively, the cores 128, 132 could be made from a material such as a nickel-iron ally know as mu-metal, which has a relative permittivity of approximately 35,000 by comparison with iron at 5000. If the core is made of mu-metal, the displacement is approximately 7 times larger, or 70 microns, with an applied current of 1 A, likely breaking the fiber. These calculations strongly suggest that a wide range of acceptable forces may be generated using merely a modest drive current. These forces are understood to create optically significant perturbations in the optical fiber.

As also illustrated in FIG. 1, the perturbation assembly 100 may include one or more sensors 142 that connect to the controller 136 via a third communication link 144. In the illustrated embodiment, one sensor 142 is shown. The sensor 142 is contemplated to sense, among other things, the vibrational frequency of the optical fiber 102. The sensor 142 also may be configured to sense the magnetic fields generated by one or both of the electromagnetic coils 122, 124. The sensor 142 also may be configured to assess one or more characteristics of the laser light 146 as should be apparent to those skilled in the art.

While the sensor 142 is shown only in connection with the perturbation assembly 100, the sensor 142 may be added to any of the embodiments described herein. In addition, while only one sensor 142 is illustrated, any number of sensors may be employed without departing from the scope of the present invention.

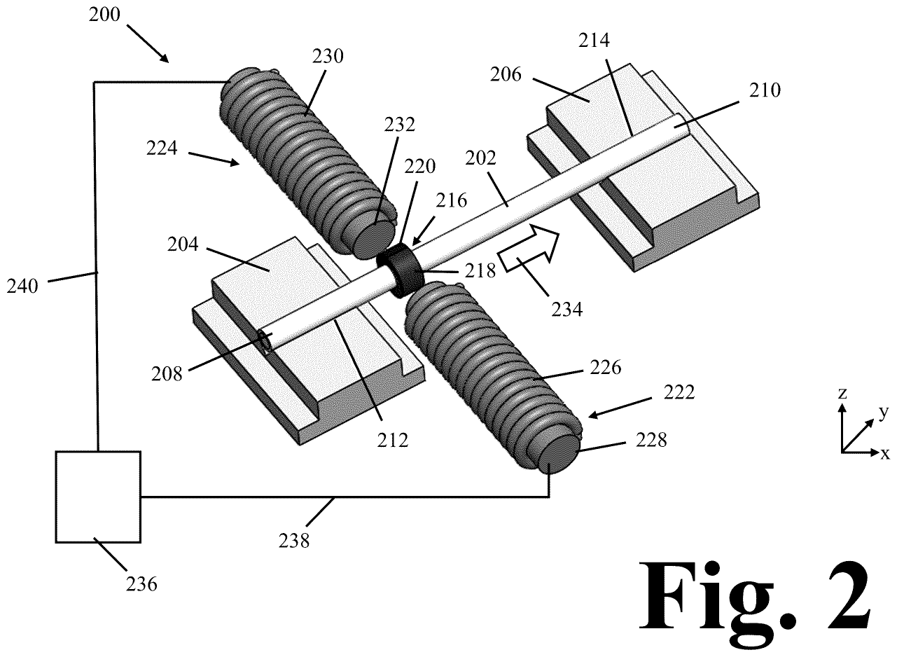

As noted above, the variables and characteristics discussed above are applicable to one or more of the other embodiments that are discussed in connection with FIGS. 2-8, below.

FIG. 2 is a perspective illustration of a second embodiment of a perturbation assembly 200 according to the present invention. The perturbation assembly 200 shares many similarities with the perturbation assembly 100.

The perturbation assembly 200 includes an optical fiber 202 that extends from a first support 204 to a second support 206. As before, the first end 208 of the optical fiber 202 is connected to the first support 204 in a first v-groove 212, and the second end 210 of the optical fiber 202 is connected to the second support 206 in a second v-groove 214. A magnet 216, with a north pole 218 and a south pole 220, is attached to the optical fiber 202 via an epoxy. A first electromagnetic coil 222 is disposed adjacent to the north pole 218 of the magnet 216, and a second electromagnetic coil 224 is disposed adjacent to the south pole 220 of the magnet 216. The first electromagnetic coil 222 combines a first coil 226 with a first core 228. The second electromagnetic coil 224 combines a second coil 230 and a second core 232. One or more characteristics of the laser light 234 are altered by operation of the electromagnetic coils 222, 224.

As with the perturbation assembly 100, the perturbation assembly 200 includes a controller 236. The controller 236 is connected to the first electromagnetic coil 222 via a first communication link 238. The second electromagnetic coil 224 is connected to the controller 236 by the second communication link 240. The controller 236 send control signals to the electromagnetic coils 222, 224 to control the movement of the magnet 216 and the optical fiber 202, thereby altering characteristics of the laser light 234 passing through the optical fiber 202.

The perturbation assembly 200 differs from the first perturbation assembly 100 in that the magnet 216 is not positioned at the center point of the optical fiber 202 between the supports 204, 206. Instead, the magnet 216 is positioned closer to the first support 204 than the second support 206. Without departing from the scope of the present invention, the magnet 216 may be positioned closer to the second support 206 than the first support 204 as should be apparent to those skilled in the art.

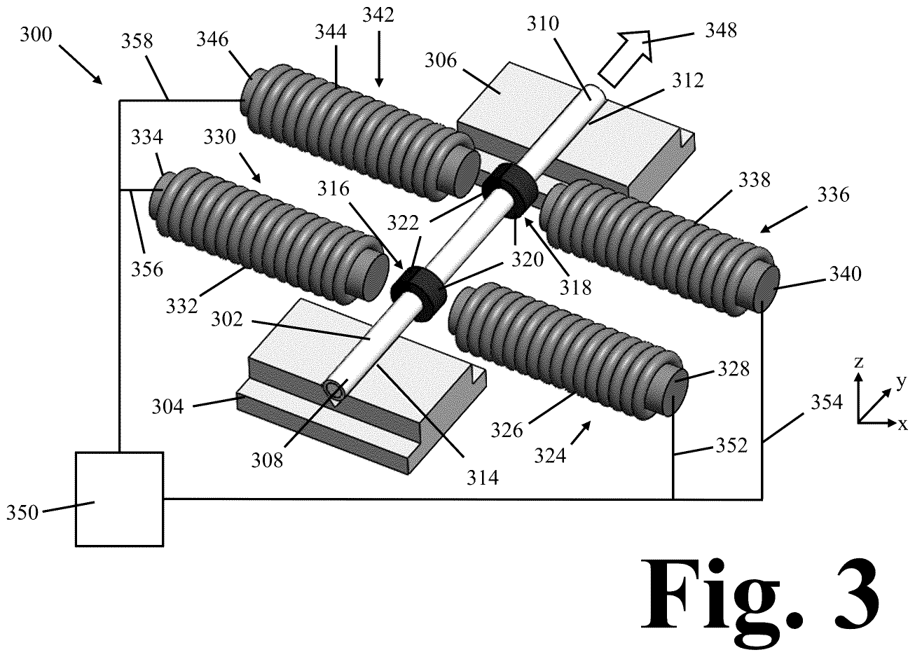

FIG. 3 is a perspective illustration of a third embodiment of a perturbation assembly 300 according to the present invention. The perturbation assembly 300 share many of the same features as the perturbation assembly 100 and the perturbation assembly 200.

The perturbation assembly 300 includes an optical fiber 302 that is disposed between a first support 304 and a second support 306. The first end 308 of the optical fiber 302 is affixed within a first v-groove 312 in the first support 304. The second end 310 of the optical fiber 302 is affixed, via an epoxy, within the second v-groove 314 in the second support 306.

In this embodiment, the perturbation assembly 300 includes two magnets, a first magnet 316 and a second magnet 318. The first and second magnets 316, 318 are affixed to the optical fiber 302 at first and second positions intermediate to the first and second supports 304, 306. As illustrated, the first magnet 316 is disposed adjacent to the first support 304. The second magnet 318 is disposed adjacent to the second support 306. As illustrated in FIG. 3, the first magnet 316 and the second magnet 318 have north poles 320 and south poles 322.

A first electromagnetic coil 324 is disposed adjacent to the north pole 320 of the first magnet 316. The first electromagnetic coil 324 includes a first coil 326 and a first core 328. A second electromagnetic coil 330 is disposed adjacent to the south pole 322 of the first magnet 316. The second electromagnetic coil 330 includes a second coil 332 and a second core 334. A third electromagnetic coil 336 is disposed adjacent to the north pole 320 of the second magnet 318. The third electromagnetic coil 336 includes a third coil 338 and a third core 340. A fourth electromagnetic coil 342 is disposed adjacent to the south pole 322 of the second magnet 318. The fourth electromagnetic coil 342 includes a fourth coil 344 and a fourth core 346.

Together, the first, second, third, and fourth electromagnetic coils 324, 330, 336, 342 apply forces to the optical fiber 302 as discussed in connection with the perturbation assemblies 100, 200. In this manner, the first, second, third, and fourth electromagnetic coils 324, 330, 336, 342 alter one or more characteristics of the laser light 348 travelling through the optical fiber 302.

As in prior embodiments, the first electromagnetic coil 324 is connected to a controller 350 via a first communication link 352. The second electromagnetic coil 330 is connected to the controller 350 via a second communication link 354. The third electromagnetic coil 336 is connected to the controller 350 via a third communication link 356. The fourth electromagnetic coil 342 is connected to the controller 350 via a fourth communication link 358.

The controller 350 is constructed and operates as discussed in connection with the perturbation assemblies 100, 200. Specifically, the controller 350 issues control/command signals that direct the operation of the electromagnetic coils 324, 330, 336, 342, thereby directing control over the characteristics of the laser light 348 within the optical fiber 302.

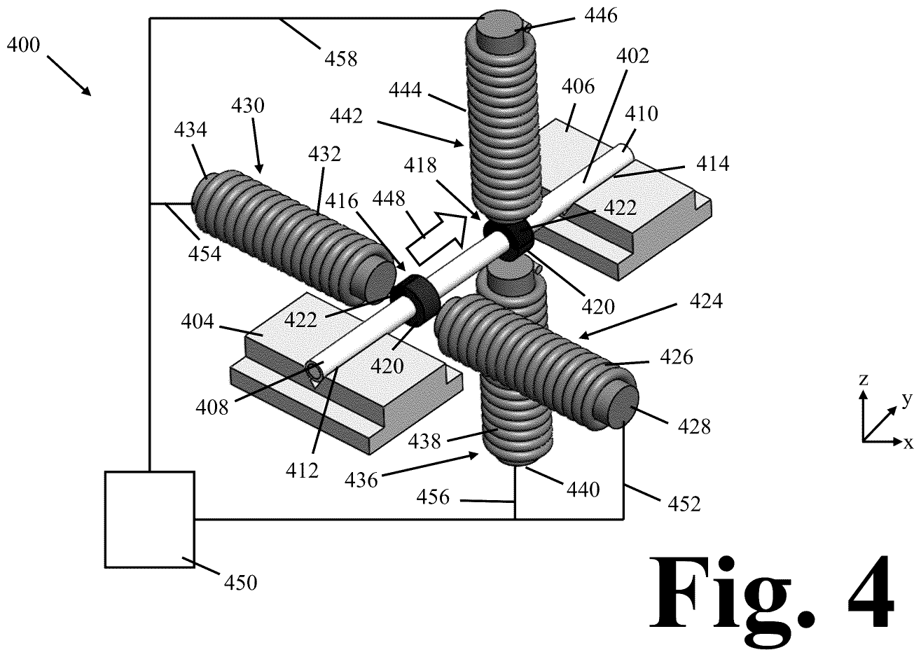

FIG. 4 is a perspective illustration of a fourth embodiment of a perturbation assembly 400 according to the present invention.

The fourth perturbation assembly 400 is similar to the third perturbation assembly 300, except that the second and fourth electromagnetic coils 436, 442 are rotated 90° by comparison with the second and fourth electromagnetic coils 330, 342 illustrated in connection with the perturbation assembly 300.

As illustrated in FIG. 4, the perturbation assembly 400 includes an optical fiber 402 that extends between a first support 404 and a second support 406. As before, the optical fiber 402 has a first end 408 is disposed in a first v-groove 412 and a second end 410 disposed in a second v-groove 414. A first magnet 416 is disposed adjacent to the first support 404, and the second magnet 418 is disposed adjacent to the second support 406.

The first magnet 416 has a north pole 420 and a south pole 422. Similarly, the second magnet 418 has a north pole and a south pole 422. Unlike the positioning of the first and second magnets 316, 318 in the perturbation assembly 300, the magnets 416, 418 are rotated 90° with respect to one another.

The perturbation assembly 400 also includes a first electromagnetic coil 424 with a first coil 426 and a first core 428, a second electromagnetic coil 430 with a second coil 432 and a second core 434, a third electromagnetic coil 436 with a third coil 438 and a third core 440, and a fourth electromagnetic coil 442 with a fourth coil 444 and a fourth core 446. The first electromagnetic coil 424 is disposed adjacent to the north pole 420 of the first magnet 416. The second electromagnetic coil 430 is disposed adjacent to the south pole 422 of the first magnet 416. The third electromagnetic coil is disposed adjacent to the north pole 420 pole of second magnet 418. The fourth electromagnetic coil 442 is disposed adjacent to the south pole 422 of the second magnet 418.

As illustrated, the third and fourth electromagnetic coils 436, 442 are rotated 90° with respect to the first and second electromagnetic coils 424, 430. It is noted that the first and second electromagnetic coils 424, 430 are considered to be oriented in a horizontal plane, consistent with the x and y axes shown. The third and fourth electromagnetic coils 436, 442 are oriented vertically, consistent with the z axis illustrated.

It is noted that the 90° orientation is not considered to be limiting of the present invention. The third and fourth electromagnetic coils 436, 442 may be rotated at any angle with respect to the first and second electromagnetic coils 424, 430 without departing from the scope of the present invention.

As in the other embodiments, the first electromagnetic coil 424, the second electromagnetic coil 430, the third electromagnetic coil 436, and the fourth electromagnetic coil 442 apply forces onto the optical fiber 402 via the first and second magnets 416, 418 to alter characteristics of the laser light 448.

A controller 450 provides signals for operation of the perturbation assembly 400. The controller 450 is connected to the first electromagnetic coil 424 via a first communication link 452, to the second electromagnetic coil 430 via a second communication link 454, to the third electromagnetic coil 436 via a third communication link 456, and to the fourth electromagnetic coil 442 via a fourth communication link 458.

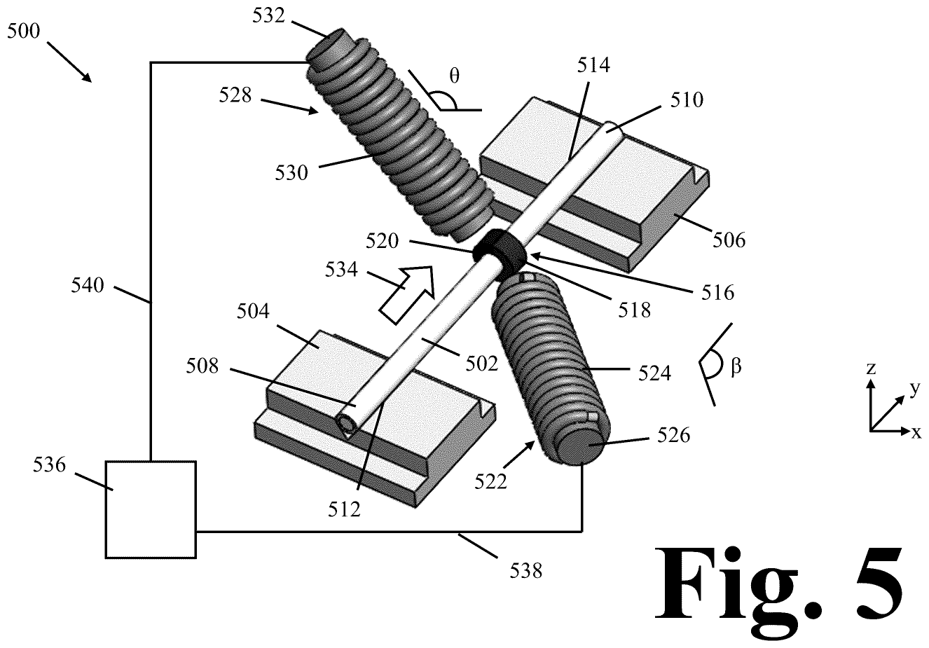

FIG. 5 is a perspective illustration of a fifth embodiment of a perturbation assembly 500 according to the present invention.

The perturbation assembly 500 is similar to the perturbation assembly 100. In this embodiment, the first electromagnetic coil 522 and the second electromagnetic coil 528 are both disposed at angles β, θ with respect to the axis of the optical fiber 502.

In this embodiment, the perturbation assembly 500 includes an optical fiber 502 that is connected between a first support 504 and a second support 506. The first end 508 of the optical fiber 502 is connected to the first support 504, within a first v-groove 512. The second end 510 of the optical fiber 502 is affixed in the second v-groove 514 in the second support 506.

A magnet 516 is disposed at a position near to the second support 506. The magnet 516 has a north pole 518 and a south pole 520.

A first electromagnetic coil 522 is positioned adjacent to the north pole 518 of the magnet 516. As before, the first electromagnetic coil has a first coil 524 and a first core 526. A second electromagnetic coil 528 is positioned adjacent to the south pole 520. The second electromagnetic coil 528 includes a second coil 530 and a second core 532.

In the perturbation assembly 500, the first electromagnetic coil 522 is angled from the axis of the optical fiber 502 by a first angle β. The second electromagnetic coil 528 is angled at a second angle θ, from the axis of the optical fiber 502. It is noted that the first and second electromagnetic coils 522, 528 may be angled in any of the axial directions (in three dimensional space) without departing from the scope of the present invention.

As with the prior embodiments, the first and second electromagnetic coils 522, 528 generate magnetic fields that push and pull on the magnet 516 to modify the characteristics of the laser light 534 travelling through the optical fiber 502.

To generate the signals and/or currents provided to the first and second electromagnetic coils 522, 528, a controller 536 is provided. The controller 536 connects to the first electromagnetic coil 528 via a first communication link 538. The controller 536 connects to the second electromagnetic coil 532 via a second communication link 540.

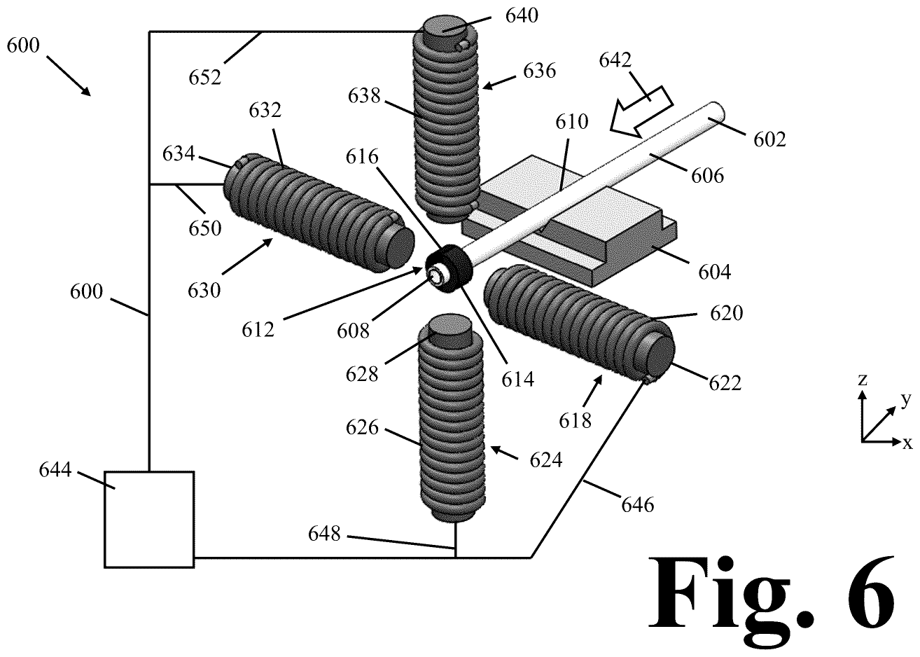

FIG. 6 is a perspective illustration of a sixth embodiment of a perturbation assembly 600 according to the present invention.

In this embodiment, the optical fiber 602 is not connected between two supports. Instead, the optical fiber 602 is connected to a single support 604 at a first end 606. The second end 608 of the optical fiber 602, however, is permitted to move freely. As in prior embodiments, the first end 606 of the optical fiber 602 is secured in a v-groove 610 in the support 604.

The optical fiber 602 includes a magnet 612 disposed on the second end 608 of the optical fiber 602. The magnet 612 has a north pole 614 and a south pole 616.

The magnet 612 is surrounded by a first electromagnetic coil 618 with a first coil 620 and a first core 622, a second electromagnetic coil 624 with a second coil 626 and a second core 628, a third electromagnetic coil 630 with a third coil 632 and a third core 634, and a fourth electromagnetic coil 636 with a fourth coil 638 and a fourth core 640. The electromagnetic coils 618, 624, 630, 636 generate magnetic fields to act on the second end 608 of the optical fiber 602, thereby affecting selected characteristics of the laser light 642.

The perturbation assembly 600 also includes a controller 644. The first electromagnetic coil 618 is connected to the controller 644 via a first communication link 646. The second electromagnetic coil 624 is connected to the controller 644 via a second communication link 648. The third electromagnetic coil 630 is connected to the controller 644 via a third communication link 650. The fourth electromagnetic coil 636 is connected to the controller 644 via a fourth communication link 652. It is contemplated that the controller 644 operates in the same manner as other controllers discussed herein.

It is contemplated that the perturbation assembly 600 may be applied to circumstances beyond the concept of bending or displacing an optical fiber, as discussed in connection with the perturbation assemblies 100, 200, 300, 400, 500. Here, for example, the perturbation assembly 600 may be employed to move the second end 608 of the optical fiber 602 so that the optical fiber 602 may be used, for example, in a fiber scanner system. In particular, the perturbation assembly 600 may be used to position the second end 608 of the optical fiber 602 in an arbitrary location on a plane. The perturbation assembly 600 also may be used for a display or switching device.

In this embodiment, the optical fiber 602 may be switched rapidly from pointing in one orientation to another by adjusting the field strength in each of the electromagnetic coils 618, 624, 630, 636. By manipulating the current applied to each electromagnetic coil 618, 624, 630, 636, the second end 608 of the optical fiber 602 may be positioned at an arbitrary point in space across a plane parallel to the fiber face and the center of the electromagnetic coils 618, 624, 630, 636.

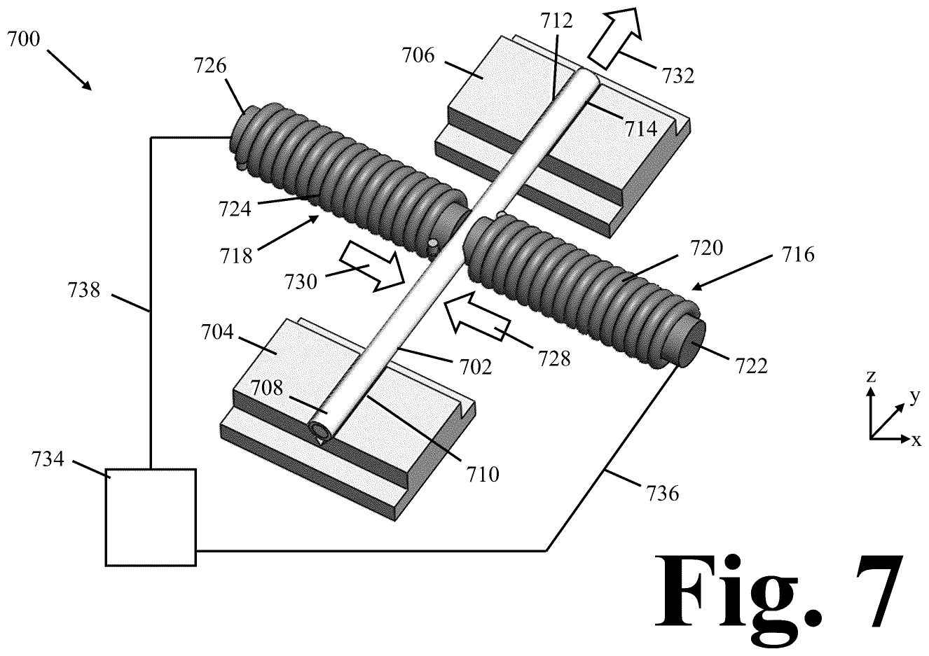

FIG. 7 illustrates a seventh embodiment of a perturbation assembly according to the present invention. This embodiment shares many similarities with the perturbation assembly 100 illustrated in FIG. 1.

In this embodiment, instead of bending the optical fiber 702, the perturbation assembly compresses the optical fiber 702 to alter selected characteristics of the laser light 732 conducted therein.

The perturbation assembly 700 includes an optical fiber 702 suspended between a first support 704 and a second support 706. As before, the first end 708 of the optical fiber 702 is affixed with a first v-groove 710 in the first support 704. Similarly, the second end 712 of the optical fiber 702 is affixed in a second v-groove 714 in the second support 706.

A first electromagnetic coil 716 is disposed on one side of the optical fiber 702. A second electromagnetic coil 718 is disposed on the opposite side of the optical fiber 702. The first electromagnetic coil 716 includes a first coil 720 and a first core 722. The second electromagnetic coil 718 includes a second coil 724 and a second core 726.

In this embodiment, the electromagnetic coils 716, 718 are positioned to apply a first compressive force 728 and a second compressive force 730 to the optical fiber 702. The application of one or both of the compressive forces 728, 730 alters selected characteristics of the laser light 732 passing through the optical fiber 702.

The first electromagnetic coil 716 is connected to a controller 734 via a first communication link 736. The second electromagnetic coil 718 is connected to the controller 734 via a second communication link 738.

The controller 734 issues and/or controls signals to the electromagnetic coils 716, 718 so that the electromagnetic coils 716, 718 generate the compressive forces 728, 730 on the optical fiber 702. It is noted that the compressive forces 728, 730 may be applied at the same time or at different times as required and/or desired. Moreover, one or both of the electromagnetic coils 716, 718 may be configured to apply a pulling force, opposite to the direction of the compressive forces 728, 730, as may be suitable to alter one or more characteristics of the laser light 732.

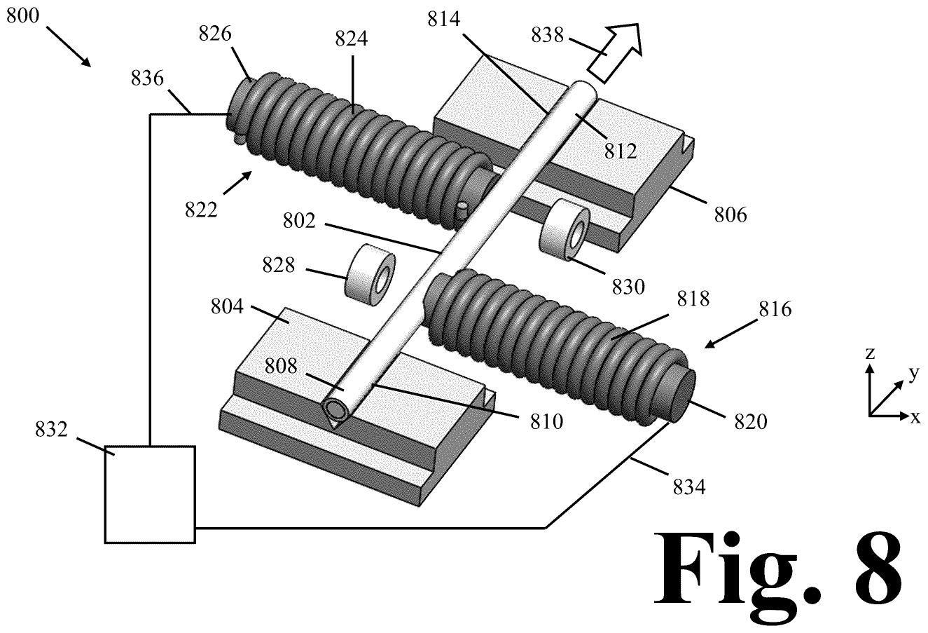

FIG. 8 is a perspective illustration of an eighth embodiment of a perturbation assembly 800 according to the present invention.

In this embodiment, the perturbation assembly 800 includes an optical fiber 802 suspended between a first support 804 and a second support 806. As before the first end 808 of the optical fiber 802 is disposed in a first v-groove 810 in the first support 804. The second end 812 of the optical fiber 802 is disposed in a second v-groove 814 in the second support 806.

A first electromagnetic coil 816 is disposed adjacent to one side of the optical fiber 802. The first electromagnetic coil 816 includes a first coil 818 and a first core 820. A second electromagnetic coil 822 is disposed on the other side of the optical fiber 802. The second electromagnetic coil 822 includes a second coil 824 and a second core 826.

The perturbation assembly 800 also includes a first magnet 830 and a second magnet 832. The first magnet 828 is disposed adjacent to the first electromagnetic coil 816, on the side opposite to that of the electromagnetic coil 816. Similarly, the second magnet 830 is disposed adjacent to the second electromagnetic coil 822, on the side opposite to that of the second electromagnetic coil 822.

The first and second magnets 828, 830 are contemplated to be permanent magnets. As such, the magnets 828, 830 are contemplated to compliment the operation of the electromagnetic coils 816, 822. The magnets 828, 830 are contemplated to increase the pushing and/or pulling action of the electromagnetic coils 816, 822. Alternatively, the magnets 828, 830 may be employed to dampen and/or retard the pushing and/or pulling action of the electromagnetic coils 816, 822.

A controller 832 is connected to the first electromagnetic coil 816 via a first communication link 834. The second electromagnetic coil 822 is connected to the controller 832 via a second communication link 836.

As with the perturbation assembly 700, the electromagnetic coils 816, 822 are contemplated to push and/or pull on the optical fiber 802. Here, the electromagnetic coils 816, 822 are offset from one another.

As should be apparent from the foregoing, the perturbation assemblies 100, 200, 300, 400, 500, 600, 700, 800 each relies on the operation of one or more electromagnetic coils. The electromagnetic coils are contemplated to vibrate the optical fiber at one or more frequencies as provided by the controller. “Vibration” of the optical fiber includes compressing the optical fiber, as provided by the perturbation assembly 700, for example.

The operational frequency of the electromagnetic coils is contemplated to fall within a range of 100 Hz to 50,000 Hz (or 40 kHz). It is contemplated that the preferred operational frequency may be about 30 kHz-50 kHz, with 40 kHz being one target frequency.

Contemplated ranges for the operational frequency include, but are not limited to, 40 kHz±10%, 40 KHz±5%, 40 kHz±2%, and 40 kHz±1%. The operational frequency includes vibration of the optical fiber. The operational frequency also encompasses compressive and/or pulling actions of the optical fiber.

Concerning the displacement distance of the optical fiber from a rest position, it is contemplated that one maximum displacement is 100 μm. A larger displacement from the rest position is contemplated to have a high potential for rupture and/or breakage of the optical fiber.

It is contemplated that the electromagnetic coils may be controlled so that the electromagnetic coils operate in a steady state mode. Also, the electromagnetic coils may operate at a constant frequency of, for example, 40 kHz. Still further, it is contemplated that the electromagnetic coils will be controlled, by the controller, according to a predetermined program suitable for the particular perturbation assembly. If so, the operational frequencies are contemplated to vary as a function of the control sequence applied to the optical fiber.

For the various embodiments of the perturbation assemblies 100, 200, 300, 400, 500, 600, 700, 800 described hereinabove, the specific configurations described are not intended to limit the present invention. Variations and equivalents that are apparent to those skilled in the art are intended to be encompassed by the present invention. Still further, features from one embodiment of the perturbation assemblies 100, 200, 300, 400, 500, 600, 700, 800 may be combined and/or substituted without departing from the scope of the present invention.

What is claimed is:

1. A perturbation assembly, comprising:
an optical fiber having a first end and a second end;
a first support, wherein the first end of the optical fiber is secured to the first support;
a first electromagnetic coil disposed adjacent to the optical fiber;
a controller; and
a first communication link connecting the first electromagnetic coil to the controller,
wherein, in response to receipt of a control signal from the controller, the first electromagnetic coil vibrates the optical fiber at a frequency within a range of 100 Hz to 50 kHz.

2. The perturbation assembly of claim 1, wherein the first support further comprises:
a first v-groove within which the first end of the optical fiber is secured; and
an epoxy adhering the first end of the optical fiber within the v-groove.

3. The perturbation assembly of claim 1, wherein the first electromagnetic comprises:
a first core; and
a first coil disposed around the first core.

4. The perturbation assembly of claim 1, wherein the frequency falls within a range of 40 kHz±10%.

5. The perturbation assembly of claim 1, wherein the frequency falls within a range of 40 kHz±5%.

6. The perturbation assembly of claim 1, wherein the frequency falls within a range of 40 kHz±2%.

7. The perturbation assembly of claim 1, wherein the frequency falls within a range of 40 kHz±1%.

8. The perturbation assembly of claim 1, further comprising:
a second electromagnetic coil disposed adjacent to the optical fiber;
a second communication link connecting the second electromagnetic coil to the controller,
wherein, in response to receipt of a control signal from the controller, the second electromagnetic coil vibrates the optical fiber at the frequency.

9. The perturbation assembly of claim 1, further comprising:
a first magnet disposed on the optical fiber between the first end and the second end,
wherein the first electromagnetic coil generates a magnetic field that interacts with the first magnet to vibrate the optical fiber at the frequency.

10. The perturbation assembly of claim 9, further comprising:
a second electromagnetic coil disposed adjacent to the optical fiber;
a second communication link connecting the second electromagnetic coil to the controller,
wherein the second electromagnetic coil generates a magnetic field that interacts with the first magnet to vibrate the optical fiber at the frequency in cooperation with the first electromagnetic coil.

11. The perturbation assembly of claim 1, wherein the controller provides the control signal to the first electromagnetic coil to vary the frequency according to a predetermined operational sequence.

12. The perturbation assembly of claim 1, further comprising:
a second support, wherein the second end of the optical fiber is secured to the second support.

13. The perturbation assembly of claim 1, further comprising:
a second electromagnetic coil disposed adjacent to the optical fiber; and
a second communication link connecting the second electromagnetic coil to the controller,
wherein, in response to receipt of a control signal from the controller, the second electromagnetic coil vibrates the optical fiber at a frequency within a range of 100 Hz to 50 kHz, and
wherein the second electromagnetic coil cooperates with the first electromagnetic coil to vibrate the optical fiber.

14. The perturbation assembly of claim 8, further comprising:
a second magnet disposed on the optical fiber between the first end and the second end.

15. The perturbation assembly of claim 13, further comprising:
a third electromagnetic coil disposed adjacent to the optical fiber;
a third communication link connecting the third electromagnetic coil to the controller,
a fourth electromagnetic coil disposed adjacent to the optical fiber;
a fourth communication link connecting the fourth electromagnetic coil to the controller,
wherein, in response to receipt of a control signal from the controller, the third and fourth electromagnetic coils vibrate the optical fiber at the frequency, and
wherein the third electromagnetic coil cooperates with the fourth electromagnetic coil to vibrate the optical fiber in association with the second magnet.
